(19) United States
(12) Patent Application Publication
(10) Pub. No.: US 2011/0232197 A1
(43) Pub. Date: Sep. 29, 2011

(54) Window regulator apparatus for vehicle

(75) Inventors: Shigeyuki Suzuki, Kariya-shi (JP); Atsushi Matsuoka, Novi, MI (US); Takuya Kotani, Kariya-shi (JP)

(73) Assignee: Aisin Seiki Kabushiki Kaisha

(21) Appl. No.: 13/064,434

(22) Filed: Mar. 24, 2011

(30) Foreign Application Priority Data
Mar. 25, 2010 (JP) 2010-070954

(51) Int. Cl. E05F 11/48; B60J 1/17

(52) U.S. Cl. 49/352

(57) ABSTRACT

A window regulator apparatus for a vehicle includes a wire adapted to be connected to a window panel movably supported by a vehicle door, a base plate adapted to be fixed to a panel of the vehicle door and having an elongated shape, the base plate extending along a vertical movement direction of the window panel on a different surface from a surface on which the window panel moves in the vertical movement direction, a pair of pulleys rotatably supported by upper and lower ends of the base plate and arranging the wire at the panel, a drum rotatably supported by an intermediate portion of the base plate, and a stopper member supported by the base plate and adjustably positioned in the vertical movement direction, the stopper member being contactable with the window panel.

### CROSS REFERENCE TO RELATED APPLICATIONS

This application is based on and claims priority under 35 U.S.C. §119 to Japanese Patent Application 2010-070954, filed on Mar. 25, 2010, the entire content of which is incorporated herein by reference.

### TECHNICAL FIELD

This disclosure relates to a window regulator apparatus for a vehicle.

### BACKGROUND DISCUSSION

A known door window regulator apparatus (window regulator apparatus) for a vehicle, disclosed in JP2005-232864A (hereinafter referred to as Reference 1) includes a rail, a carrier plate (carrier bracket), pulleys, a wire, and a drive mechanism. The rail is vertically arranged at a lower side of a window formed in a door panel. The carrier plate is movably attached to the rail along a vertical direction of the rail by engaging with side edges of the rail in a horizontal direction of the rail, thereby supporting a lower end portion of a window glass. The pulleys are arranged adjacent to upper and lower ends, respectively, of the rail. Both ends of the wire are fixed to the carrier plate and are wound on the pulleys that are arranged adjacent to the upper and lower ends of the rail. The drive mechanism drives the wire to thereby vertically move the carrier plate along the rail.

According to the window regulator apparatus disclosed in Reference 1, the carrier plate supporting the lower end portion of the window glass engages with the side edges of the rail and serves as a guide member guiding therealong the window glass and vertically moving the window glass. In addition, a stopper member regulating a downward movement of the window glass along the vertical direction of the guide rail is fixed to the lower end of the rail. Accordingly, a configuration of the window regulator apparatus described in Reference 1 may not be applicable to different trajectories or strokes of vertical movements of various window glasses.

A need thus exists for a window regulator apparatus for a vehicle, which is not susceptible to the drawback mentioned above.

### SUMMARY

According to an aspect of this disclosure, a window regulator apparatus for a vehicle includes a wire adapted to be connected to a window panel movably supported by a vehicle door, a base plate adapted to be fixed to a panel of the vehicle door and having an elongated shape, the base plate extending along a vertical movement direction of the window panel on a different surface from a surface on which the window panel moves in the vertical movement direction, a plurality of pulleys rotatably supported by upper and lower ends of the base plate and arranging the wire relative to the base plate, a drum rotatably supported by an intermediate portion of the base plate, and a stopper member supported by the base plate and adjustably positioned in the vertical movement direction, the stopper member being contactable with the window panel.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an overview of a window regulator apparatus for a vehicle, according to an embodiment disclosed here, as seen from an inner side of a vehicle door to which the window regulator apparatus is attached;

FIG. 2A is a schematic view of the window regulator apparatus according to the embodiment disclosed here, as seen from an outer side of the vehicle door;

FIG. 2B is an enlarged perspective view of a carrier bracket shown in FIG. 2A;

FIG. 3 is a front view of an elongated bore formed in a base plate;

FIG. 4 is a perspective view mainly illustrating a stopper member attached to the base plate;

FIG. 5 is a cross-sectional view illustrating an upper portion of the base plate to which pulleys are fixed;

FIG. 6 is a cross-sectional view illustrating a lower portion of the base plate to which the pulleys are fixed; and

FIG. 7 is a cross-sectional view (taken along the line VII-VII of FIG. 4) mainly illustrating the stopper member attached to the base plate.

### DETAILED DESCRIPTION

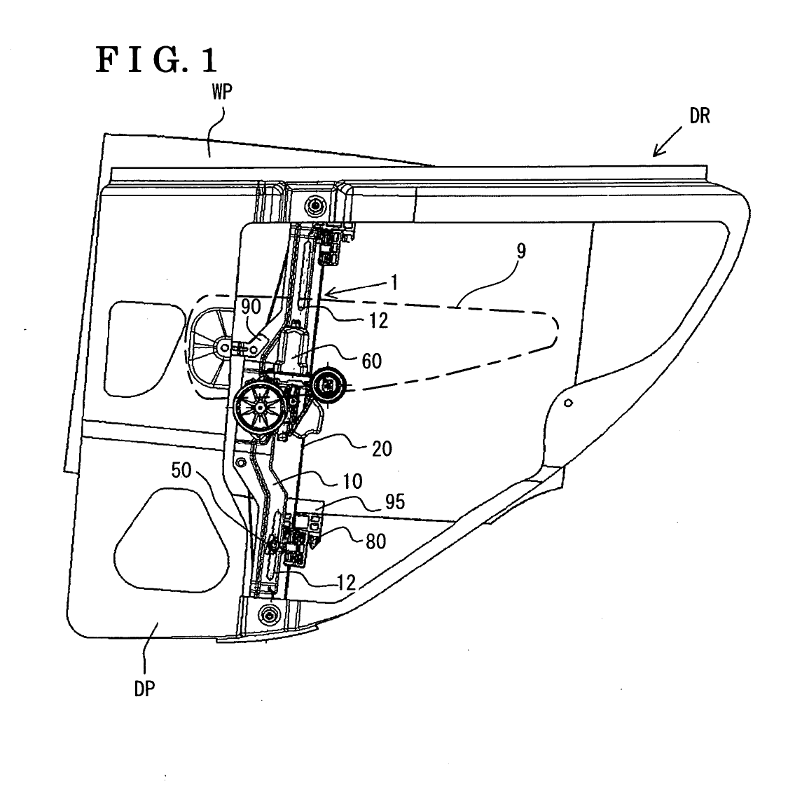

An embodiment of this disclosure will be described as follows with reference to illustrations of FIGS. 1 to 7.

As illustrated in FIG. 1, a window regulator apparatus 1 for a vehicle, according to the embodiment is arranged in a vertical direction of the vehicle. The window regulator apparatus 1 is attached to a door inner panel (door panel) DP in the vertical direction by means of tightening members positioned at upper and lower sides of the door panel DP (the door panel DP serves as a panel). The window regulator apparatus 1 vertically moves a window panel WP that is movably supported by a vehicle door DR in the vertical direction.

The window panel WP is vertically moved by the window regulator apparatus 1 along a trajectory of a vertical movement regulated by a guide member. The window regulator apparatus 1 is arranged on a different surface from a surface on which the window panel WP moves in the vertical movement direction.

The window regulator apparatus 1 mainly includes a base plate 10, a wire 20, a drum 30, a pair of pulleys 40 arranged in the vertical direction, and a stopper member 50. The base plate 10 is fixed to the door panel DP in the vertical direction. The wire 20 is connected to the window panel WP so as to vertically move the window panel WP. The drum 30 rolls thereout and therein the wire 20. The wire 20 is arranged at the door panel DP by the pair of pulleys 40. The stopper member 50 regulates a downward movement of a lower edge of the window panel WP.

The base plate 10 is an elongated member having a flat surface and extending in the vertical direction (corresponding to a vertical moving direction of the window panel WP). The base plate 10 is configured so that upper and lower portions from an intermediate portion in the vertical direction are symmetric to each other. Accordingly, the base plate 10 may be utilized to the vehicle doors DR arranged at both right and left sides of the vehicle.

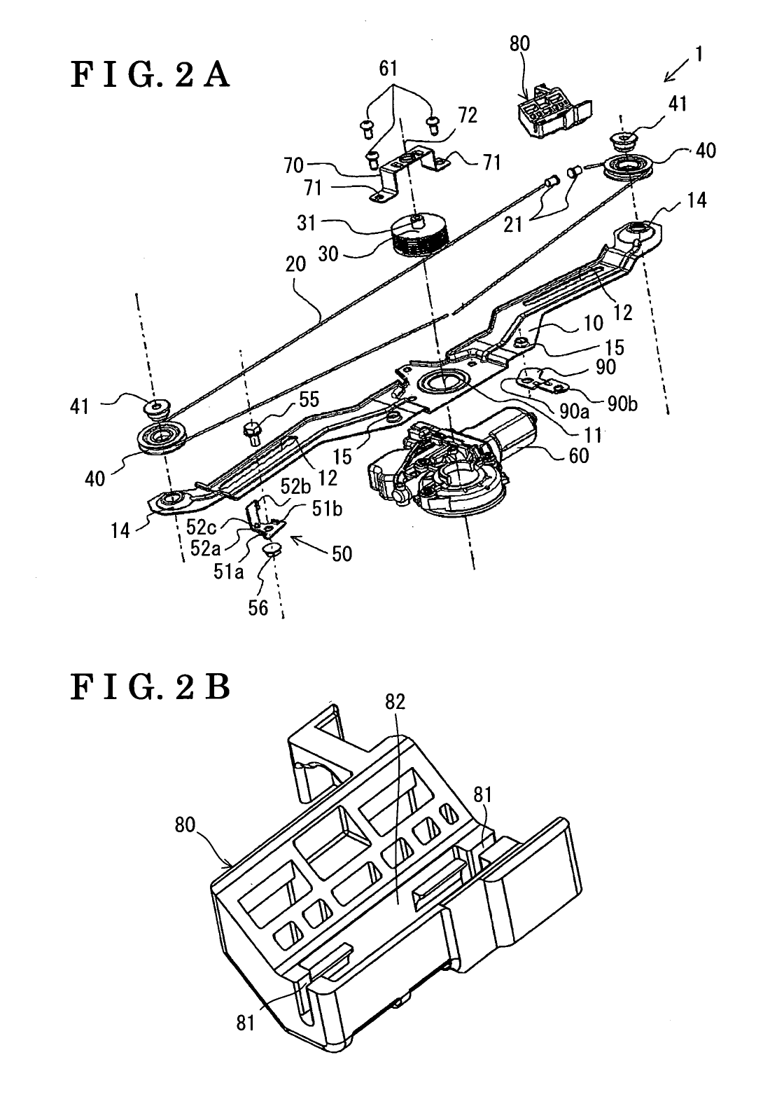

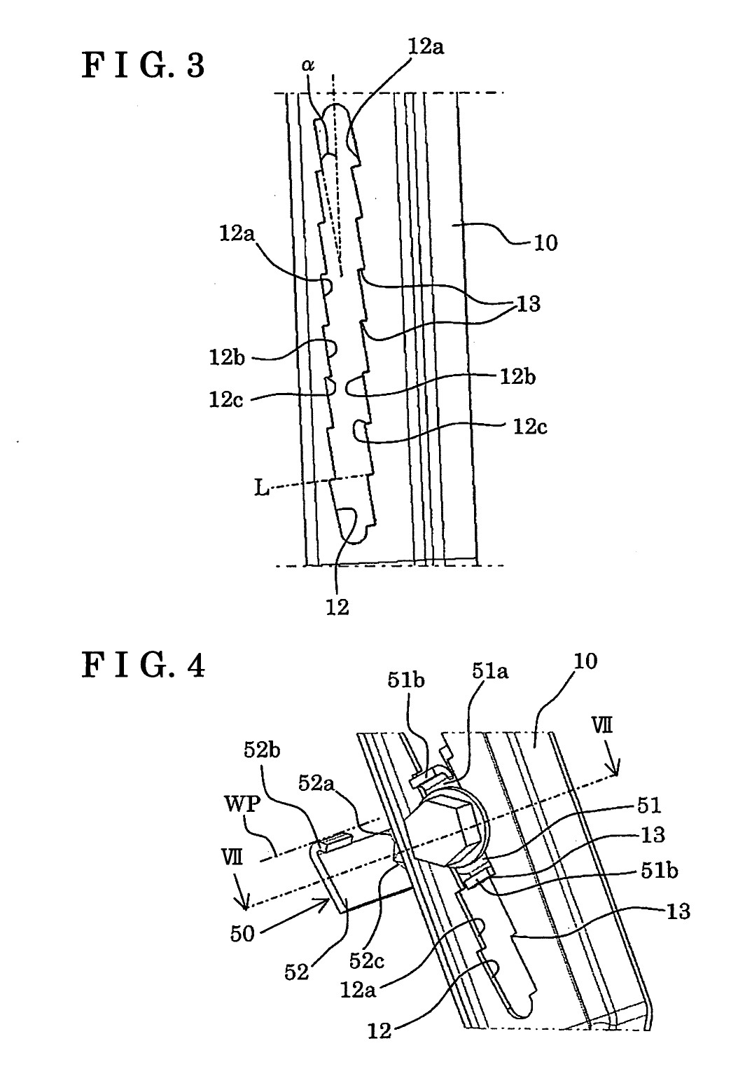

An intermediate bore 11 to which the drum 30 is attached is formed in the intermediate portion of the base plate 10. Elongated bores 12 extending in the vertical direction are formed in the upper and lower portions, respectively, of the base plate 10. As illustrated in FIG. 3, stepwise linear portions 12a are formed side by side at side edges of each of the elongated bores 12 in the vertical direction. Each of the stepwise linear portions 12a includes long sides 12b and short sides 12c. Each of the long sides 12b is inclined by a predetermined angle a relative to the vertical direction. Each of the short sides 12c continuously formed with the long side 12b is perpendicular thereto. The short sides 12c at the respective side edges of the elongated bore 12 are formed so as to be linearly positioned on a straight line L shown in FIG. 3. A plurality of corners each defined by the long side 12b and the short side 12c projects toward an inner side of the elongated bore 12 in a horizontal direction seen in FIG. 3. The plurality of corners configures a plurality of engagement protrusions 13 engageable with the stopper member 50. In addition, as shown in FIG. 2, pulley bores 14 to which the respective pulleys 40 are attached are formed in upper and lower ends of the base plate 10. Tightening bores 15 are formed at upper and lower sides of the intermediate bore 11. An arm rest 9 on which an arm of an occupant is placed is attached to one of the tightening bores 15. The arm rest 9 serving as an interior decorating member for the vehicle door DR is fixed to the base plate 10 by utilizing the tightening bore 15 (see FIG. 1). A reinforcement bracket 90 includes a through hole 90a and a bore 90b at first and second ends, respectively. The second end of the reinforcement bracket 90 is connected to the door panel DP by the bore 90b. The first end of the reinforcement bracket 90 is fixed or welded to a portion that is adjacent to the tightening bore 15. The through hole 90a at the first end of the reinforcement bracket 90 overlaps the tightening bore 15. When the arm rest 9 is being fixed to the base pate 10, an arm-rest tightening member such as a screw is screwed with the tightening bore 15 via the through hole 90a. Thus, the portion (adjacent to the tightening bore 15) of the base plate 10 to which the arm rest 9 is fixed is reinforced by the base reinforcement bracket 90, therefore firmly supporting the arm rest 9 relative to the base plate 10.

The drum 30 formed in a circular cylinder includes multiple grooves continuously formed at an outer circumferential side approximately along a circumferential direction. The drum 30 is mechanically connected to a drive mechanism 60 so as to be rotated thereby in clockwise and counterclockwise directions. The drum 30 and the drive mechanism 60 are attached to the base plate 10 by means of tightening members 61 in a condition where the base plate 10 is positioned between the drum 30 and the drive mechanism 60 and a connecting member is inserted into the intermediate bore 11 of the base plate 10. The drum 30 includes a protruding portion 31 formed in a circular cylinder. The protruding portion 31 protrudes toward an opposite direction from a portion of the drum 30, which is attached to the drive mechanism 60. Further, a support bracket 70 having both ends 71 and a bore 72 is fixed to the base plate 10. In particular, the both ends 71 of the support bracket 70 are fixed to the base bracket 10 and the bore 72 is formed in a protruded surface arranged between the both ends 71 and protruding toward substantially the same direction as the protruding portion 31 of the drum 30. The protruding portion 31 is rotatably supported by the bore 72 of the support bracket 70.

As illustrated in FIG. 4, the stopper member 50 includes an engagement flange 51 slidably supported by the elongated bore 12 of the base plate 10, and a contact flange 52 integrally formed with the engagement flange 51 and contactable with the lower edge of the window panel WP. The contact flange 52 protrudes from an approximately intermediate portion of the engagement flange 51. Thus, the engagement flange 51 and the contact flange 52 substantially form a T-shape of the stopper member 50.

As illustrated in FIGS. 2 and 4, the engagement flange 51 is formed by a flange portion 51a sliding on the base plate 10, and engagement portions 51b. A bolt 55 and a nut 56 (fixing members) that fix the stopper member 50 to the base plate 10 are in contact with the flange portion 51a. The engagement portions 51b are curved at upper and lower ends, respectively, of the flange portion 51a in the vertical moving direction while extending toward the base plate 10. Each of the engagement portions 51b is slidably supported by the elongated bore 12 to be engageable with each of the engagement protrusions 13 accordingly.

The contact flange 52 is formed by a flange portion 52a and a contact portion 52b. The flange portion 52a extends in a direction in which the long side 12a is inclined toward the intermediate bore 11 of the base plate 10. The contact portion 52b is continuously formed with the flange portion 52a and curved from an upper end of the flange portion 52a toward the base plate 10 so as to substantially have a U-shape in cross section. The contact portion 52b makes contact with a carrier bracket 80 connected to the window panel WP by a window bracket 95 (the carrier bracket 80 and the window bracket 95 will be described below). A rib 52c having a wedge shape is formed at the curved portion between the flange portion 52a and the contact portion 52b, thereby increasing the strength of the stopper member 50 when the carrier bracket 80 is brought into contact with the stopper bracket 50 by the downward movement of the window panel WP.

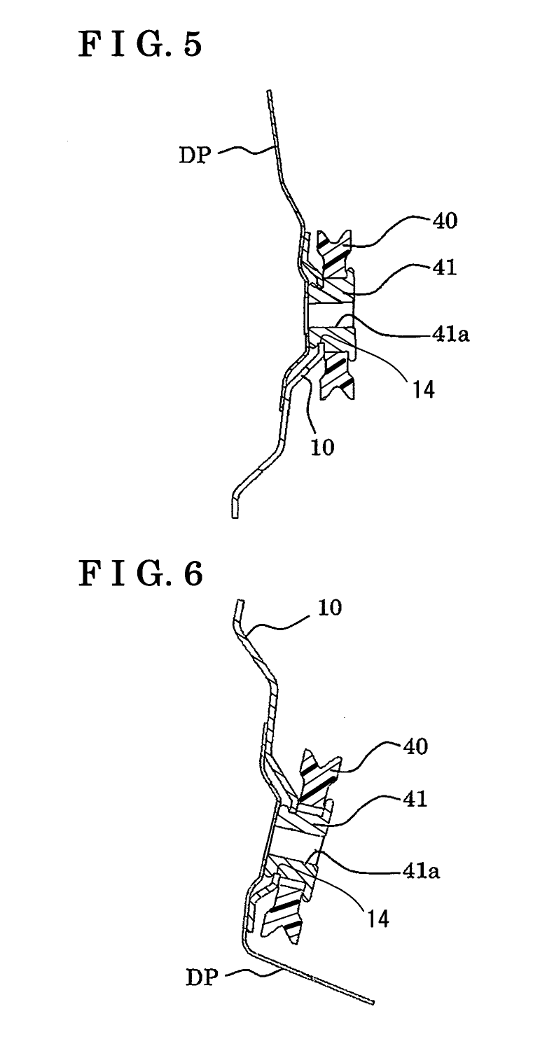

The pulleys 40 identical to each other are arranged at the upper and lower ends, respectively, of the base plate 10. A groove having an approximate V-shape seen in cross section is formed in an outer circumferential side of each pulley 40. As illustrated in FIGS. 5 and 6, the pulley 40 is rotatably supported by a pulley pin 41 relative to the base plate 10. The pulley pin 41 is inserted in the pulley bore 14 and fixedly press-fitted to the base plate 10. A threaded portion 41a is formed in the center of the pulley bore 14. The tightening member fixing the pulley pin 41 to the door panel DP is screwed with the threaded portion 41a.

The wire 20 is rolled around the drum 30 and the pulleys 40. End portions 21 are fixed at both ends of the wire 20. The end portions 21 of the wire 20 are locked to the carrier bracket 80 connected to the window panel WP. The carrier bracket 80 includes a recessed portion 82 extending along a vertical movement direction (the vertical direction). Grooves 81 are formed at both upper and lower sides of the recessed portion 82. The end portions 21 of the wire 20 are inserted in the grooves 81, respectively, of the recessed portion 82 so as to extend therethrough along the vertical movement direction. The carrier bracket 80 is connected to the window panel WP by the window bracket 95 fixed to the window panel WP.

How to attach the window regulator apparatus 1 to the door panel DP will be described as follows.

The base plate 10 is arranged at an outer side of the door panel DP while being in contact therewith in such a way that the drum 30 and the drive mechanism 60 face exterior and interior sides, respectively, of the vehicle; thereby, the window regulator apparatus 1 is assembled to the door panel DP. Further, the tightening members are inserted through bores, which are formed at the upper and lower side of the door panel DP, from the interior side of the vehicle. Then, the tightening members are screwed with the threaded portions 41a of the pulley pins 41. Thus, the window regulator apparatus 1 is fixed to the door panel DP. In addition, the arm-rest tightening member is screwed with the tightening bore 15 through the through hole 90a at the first end of the reinforcement bracket 90; thereby, the arm rest 9 is fixed to the base plate 10.

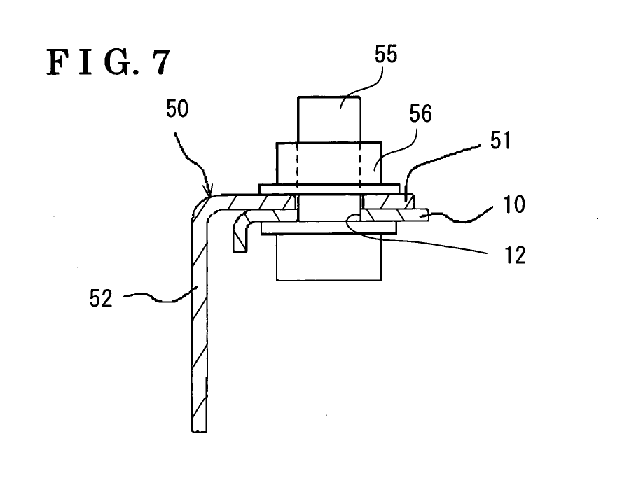

The stopper member 50 is supported by the base plate 10 while being adjustably positioned in the vertical direction. In other words, the stopper member 50 slides on the base plate 10 while engaging with the elongated bore 12. Thus, the position of the stopper member 50 is adjustable in a vertical direction of the elongated bore 12 determined depending on types of vehicles to which the window regulator apparatus 1 is attached. One of the engagement portions 51b of the engagement flange 51, which is located at a lower side of the elongated bore 12, is brought into contact with the engagement protrusion 13 that is adjacent to the engagement portion 51b of the lower side in the vertical direction of the elongated bore 12. Further, the engagement flange 51 and the base plate 10 are sandwiched by the bolt 55 and the nut 56 as illustrated in FIG. 7. As a result, the stopper member 50 is positioned in the vertical direction of the elongated bore 12 determined depending on types of vehicles.

An operation of the window regulator apparatus 1 will be explained as follows. In particular, a case where the downward movement of the window panel WP is regulated by the stopper member 50 will be described.

When the window panel WP moves downward, the window panel WP makes contact with the stopper 50. At this time, a rotating moment is generated at the stopper member 50 by the contact between the lower edge of the window panel WP and the contact portion 52b.

The stopper member 50 is guided along the elongated bore 12 by the long sides 12b each inclined by the predetermined angle a relative to the vertical direction toward the intermediate bore 11 of the base plate 10, and by the short sides 12c perpendicular to the long sides 12b; therefore, the rotation of the stopper member 50 may be generated. As a result, the engagement portion 51b is further engaged with the engagement protrusion 13 by the rotation of the stopper member 50 to therefore effectively regulate the downward movement of the window panel WP.

As described above, according to the aforementioned embodiment, the window regulator apparatus 1 includes the wire 20 adapted to be connected to the window panel WP movably supported by the vehicle door DR, the base plate 10 adapted to be fixed to the door panel DP of the vehicle door DR and having the elongated shape, the base plate 10 extending along the vertical movement direction of the window panel WP on the different surface from the surface on which the window panel WP moves in the vertical movement direction, the pair of pulleys 40 rotatably supported by the upper and lower ends of the base plate 10 and arranging the wire 20 at the door panel DP, the drum 30 rotatably supported by the intermediate portion of the base plate 10, and the stopper member 50 supported by the base plate 10 and adjustably positioned in the vertical movement direction, the stopper member 50 being contactable with the window panel WP.

Thus, the base plate 10 is positioned on the different surface from the surface on which the window panel WP moves in the vertical movement direction, while not directly guiding the window panel WP in the vertical movement direction. Further, the stopper member 50 may support the window panel WP so as to selectively position the window panel WP in the vertical movement direction. Accordingly, the installability of the window regulator apparatus 1 relative to various types of vehicles may increase while not being affected by different trajectories or strokes of vertical movements of window glasses of the vehicles, respectively.

According to the aforementioned embodiment, the base plate 10 includes the elongated bore 12 formed to extend in the vertical movement direction and having the engagement protrusions 13. The stopper member 50 includes the engagement flange 51 slidably supported by the elongated bore 12 and engageable with each engagement protrusion 13, and the contact flange 52 contactable with the window panel WP.

Accordingly, the engagement protrusion 13 and the engagement flange 51 engage with each other, thereby appropriately adjusting the position of the base plate 10 in the vertical movement direction.

According to the aforementioned embodiment, the window regulator apparatus 1 further includes the reinforcement bracket 90 having the first and second ends. The base plate 10 includes the tightening bore 15 adapted to attach thereto the arm rest 9 for the vehicle door DR. The reinforcement bracket 90 is adapted to reinforce the arm rest 9 relative to the base plate 10 by the first end positioned and fixed around the tightening bore 15 of the base plate 10 and by the second end connected to the door panel DP of the vehicle door DR.

Accordingly, the portion of the base plate 10 to which the arm rest 9 for the vehicle door DR is fixed is reinforced by the reinforcement bracket 90, therefore firmly supporting the arm rest 9 relative to the base plate 10.

According to the aforementioned embodiment, the base plate 10 includes the elongated bore 12. The tightening bore 15 is symmetrically formed in the vertical movement direction.

Accordingly, the base plate 10 may be utilized to the vehicle doors DR arranged at the both right and left sides of the vehicle.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A window regulator apparatus for a vehicle, comprising:
a wire adapted to be connected to a window panel movably supported by a vehicle door;
a base plate adapted to be fixed to a panel of the vehicle door and having an elongated shape, the base plate extending along a vertical movement direction of the window panel on a different surface from a surface on which the window panel moves in the vertical movement direction;
a plurality of pulleys rotatably supported by upper and lower ends of the base plate and arranging the wire relative to the base plate;
a drum rotatably supported by an intermediate portion of the base plate; and
a stopper member supported by the base plate and adjustably positioned in the vertical movement direction, the stopper member being contactable with the window panel.

2. The window regulator apparatus according to claim 1, wherein the base plate includes an elongated bore formed to extend in the vertical movement direction and having an engagement protrusion, and the stopper member includes an engagement flange slidably supported by the elongated bore and engageable with the engagement protrusion, and a contact flange contactable with the window panel.

3. The window regulator apparatus according to claim 1, wherein the base plate includes a tightening bore adapted to attach thereto an interior decorating member for the vehicle door.

4. The window regulator apparatus according to claim 2, further comprising a reinforcement bracket having first and second ends, and
wherein the reinforcement bracket is adapted to reinforce the interior decorating member relative to the base plate by the first end positioned and fixed around the tightening bore of the base plate and by the second end connected to the panel of the vehicle door.

5. The window regulator apparatus according to claim 2, wherein the base plate includes a tightening bore adapted to attach thereto an interior decorating member for the vehicle door.

6. The window regulator apparatus according to claim 5, further comprising a reinforcement bracket having first and second ends, and
wherein the reinforcement bracket is adapted to reinforce the interior decorating member relative to the base plate by the first end positioned and fixed around the tightening bore of the base plate and by the second end connected to the panel of the vehicle door.

7. The window regulator apparatus according to claim 5, wherein the base plate including the elongated bore and the tightening bore is symmetrically formed in the vertical movement direction.
